(19) United States
(12) Patent Application Publication
(10) Pub. No.: US 2005/0227196 A1
(43) Pub. Date: Oct. 13, 2005

(54) Method for applying orthodontic fixing elements

(76) Inventor: Christoph Von Mandach, Brugg (CH)

Correspondence Address: RYAN KROMHOLZ & MANION, S.C., POST OFFICE BOX 26618, MILWAUKEE, WI, 53226, US

(21) Appl. No.: 10/506,942

(22) PCT Filed: Jan. 29, 2003
(86) PCT No.: PCT/CH03/00074

§ 371 Date: Apr. 5, 2005

(30) Foreign Application Priority Data
Mar. 13, 2002 (CH) 433/02

(51) Int. Cl. A61C 3/00

(52) U.S. Cl. 433/9; 433/24

(57) ABSTRACT

The bonding of orthodontic fixing elements in a precise position on the dental surface is extremely difficult. The invention relates to a kit for this purpose, consisting of orthodontic fixing elements (10), whose bonding surface (3) is curved in a convex manner in at least one direction. This ensures that the shape of the element is adapted to the tooth by means of the adhesive. According to the invention, a protector (20), equipped with a recess that forms the complement of the orthodontic fixing element, is provided. The orthodontic fixing element comprising the protector is applied by being held in an applicator (30), equipped with various direction locators (35-38), by means of a positive fit, in such a way that a correct positioning can be clearly identified.

### FIELD OF THE INVENTION

The present invention relates to a method for the correct application of orthodontic fastening parts such as buttons, hooks, eyelets or brackets onto teeth, as well as accordingly suitable elements for carrying out the method.

### BACKGROUND OF THE INVENTION

Orthodontics amongst other things entails the correction of the position of the teeth. For this the most varied of orthodontic apparatus, but also devices for transmitting forces and/or for the fixation and stabilization of one or more teeth are necessary. With regard to the devices it is the case on the one hand of orthodontic fastening parts and on the other hand of parts for transmitting tensile and compressive forces. Whilst the tensile and compressive forces are transmitted by way of wire arches, rubber elastic pieces, metal springs and ligatures, the orthodontic fastening parts of interest here are in particular hooks, buttons, to a lesser extent eyelets, and mainly brackets.

The orthodontic parts of particular interest here may be fastened to the teeth with so-called strips of metal or they may be directly bonded (glued) onto the teeth. For an improved wearing comfort it is desirable on the one hand for the orthodontic fastening elements to be provided with a low as possible construction height and on the other hand to arrange the connection location between the fastening part and the force-transmitting part as close as possible to the tooth.

Limits are placed on these demands already alone on account of the mechanical strength, but more important is the problem that such orthodontic fastening parts on the one hand must be held by way of bonding and on the other hand their correct position relative to the tooth during the bonding must be considered.

If one considers the fact that such orthodontic fastening parts have a bonding surface as a base, whose side edges usually lie in the magnitude of 2 to 4 millimeters, then it is clear that with such dimensions an exact alignment of approx. 5° for example is an illusion. This alignment is not effected absolutely to one horizontal or vertical basic direction but is effected on the one hand relative to the axis of the tooth on which the corresponding fastening part is assembled, and on the other hand relative to the nature of the dental arch of the patient.

In particular, the correct arrangement of the brackets is significant since a so-called slot or guide groove runs in these, into which a wire arch is inserted which is preshaped such that it may transmit the suitable forces effecting the correction, onto the brackets and thus onto the teeth.

Here, purely by way of example, some patent documents which are concerned with such brackets with corresponding slots and wire arches to be accommodated in these slots are referred to. CH-A-685'853 additionally to the known slot provides a tunnel which may serve for anchoring part arches. Whilst this bracket is not equipped with a closure tab, recently various brackets have appeared on the market which are provided with a pivotable, and recently, also displaceable tab, which on the one hand may hold the arch in the slot in a clamped manner and on the other hand is secured against opening. With regard to examples of such brackets, the documents WO-00/57809, WO-00/33760, WO-01/05324 or U.S. Pat. No. 6,071,119 are referred to purely by way of example.

All these documents also show that the corresponding fastening parts, in particular here the brackets, are equipped with a suitable base plate, which on the one hand increases the base and serves as a bonding surface, and on the other hand may also effect a certain aligning effect.

### SUMMARY OF THE INVENTION

It is the object of the present invention to provide a method by way of which orthodontic fastening parts are able to be better optically controlled and accordingly may be bonded (glued) onto a tooth surface in a more exact manner whilst taking into account the corrections to be carried out.

It is a further object of the present invention to create orthodontic fastening parts for the bonding (adhesive) connection to a tooth surface, which in many cases renders superfluous any significant adaptation of the bonding (adhesive) surface to the surface of the tooth. Such an orthodontic fastening part is characterized in that the bonding surface of the fastening part comprises a surface which is convexly curved at least in one direction. They however may only be used in a more meaningful manner if the method according to the invention is also applied.

In order to be able to carry out this method according to the invention it requires a protector which the present invention likewise creates. If an orthodontic fastening part is protected by way of a protector according to the invention, then according to the main object of the invention it may be attached in a particularly positionally correct manner by way of an applicator.

Elements required for carrying out the method are represented in the accompanying drawings and are explained by way of the subsequent description, and their interaction on carrying out the method is explained.

### BRIEF DESCRIPTION OF THE DRAWINGS

FIG. 1 illustrates an orthodontic fastening part, for example a bracket.

FIG. 2 illustrates a corresponding protector adapted to the design shaping of the orthodontic fastening part according to FIG. 1.

FIG. 3 illustrates an applicator with suitable indicators, which may be placed onto the protector and envelops this.

FIG. 4 in a perspective representation shows a lock (latch) in the form of a wire bow (archwire).

FIGS. 5 and 6 show the bonding (adhesive) surface structures of a two-part fastening part of both parts individually.

FIG. 7 shows the smaller part of the two-part fastening part in a lateral view.

FIG. 8 shows the bonding (adhesive) surface structures of a two-part fastening part of both parts in the joined position.

FIG. 9 shows the lateral view of the joined parts.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

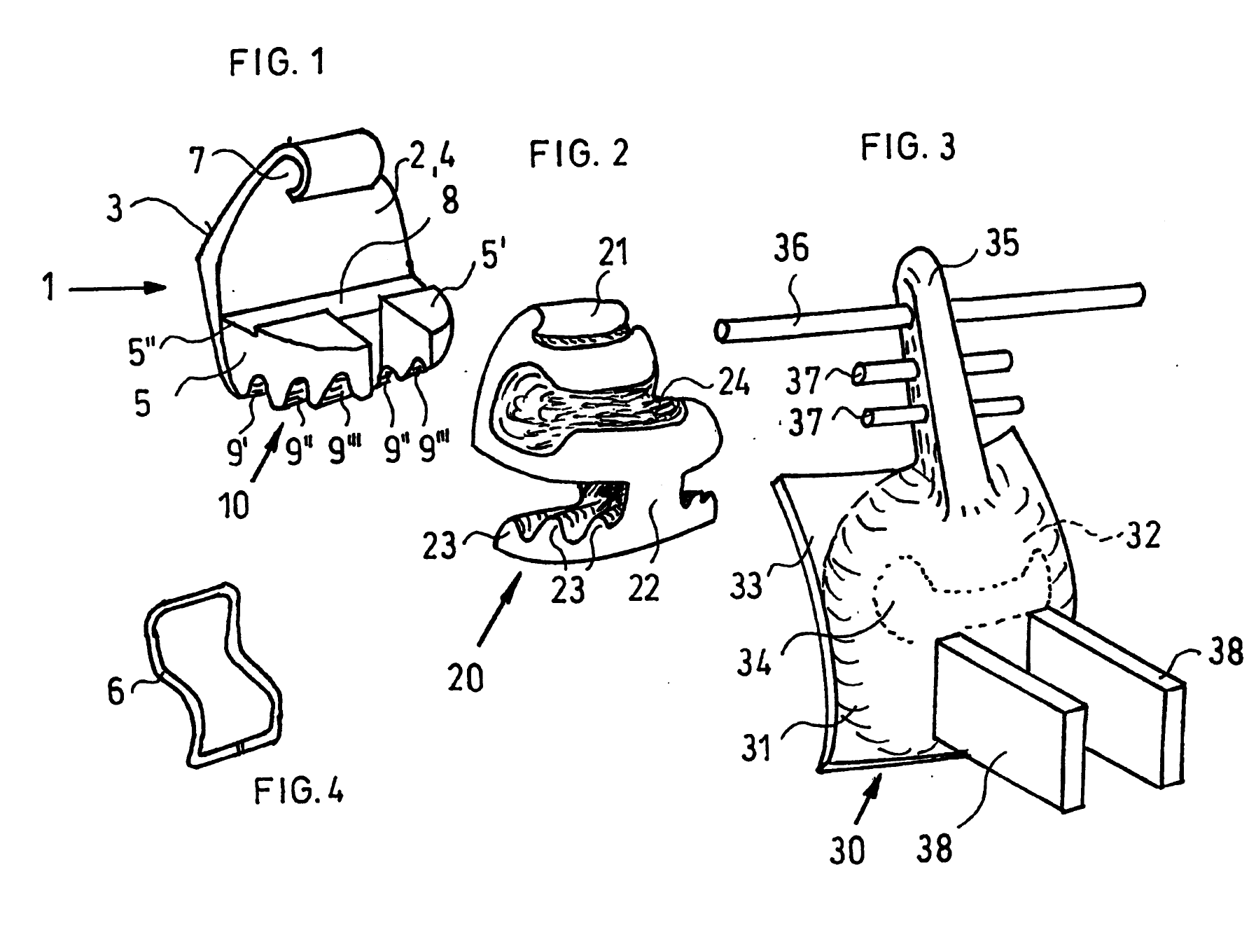

With the bracket represented in FIG. 1 it is the case of an embodiment form of an orthodontic fastening part. The embodiment shown here is not significant for the method according to the invention. As already mentioned, the fastening parts may also be hooks or eyelets, depending on the orthodontic requirements which are to be fulfilled.

For carrying out the method according to the invention one always requires three elements, specifically as a first one, an orthodontic fastening part 10, a protector of one or more parts which protectively covers that surface of the orthodontic fastening part distant to the tooth and accordingly a complementary receiver recess, wherein this protector is indicated at 20, and finally an applicator 30. Hereinafter, these elements are described in a detailed manner in the above-mentioned sequence, and finally their use with regard to the method is explained.

With the orthodontic fastening part 10 shown here it is the case of a one-part bracket which is indicated in its entirely at 1. This comprises a base 2 which is generally indicated as a base of the orthodontic fastening part. Its surface which comes to lie on the tooth surface represents the bonding surface 3 of the base 2. The base 2 lying opposite the bonding surface 3 forms a vertical bearing surface for a correction arch which is not represented here. An actual fastening element 5 is integrally formed on the base of the orthodontic fastening part 2. This fastening element 5 may have the shape of a mushroom and in this case is called a button, or may have the shape of a hooks or eyelets. In the case of a bracket this fastening element 5 is formed as a horizontal bearing surface 5′ for the already mentioned alloyed correction arch. At the same time an inlay groove 5″ for the correction arch may be provided in the horizontal bearing surface 5′. This is drawn in a dashed manner. The correction arch is held in a fixing manner on the vertical bearing surface or on the horizontal bearing surface 5′ or in the inlay groove 5″ by way of a so-called lock (latch) 6 which may be manufactured in a plate-like manner or of a wire bow (archwire) as is shown here. A suitable mounting 7 in the form of a beading is designed for mounting the corresponding wire bow (archwire) which serves as a closure spring. Various positions 9′, 9″, 9′″ in the form of grid notches for the closure spring of the lock (latch) are inwardly formed (recessed) on the lower side of the fastening element 5. The invention practically permits any shaping of a lock (latch). The fastening element 5 further comprises grid grooves 8 running vertically to the base of the orthodontic fastening part, which on the one hand serve for the correct positioning of the protector which is yet to be described, and on the other hand for the fixation of the various locks.

With regard to the orthodontic fastening part 10 it is the shaping of its base and here its bonding surface which is particularly characteristic. Whereas with conventional orthodontic fastening elements, the bonding surface 3 of the base imitates the shape of the surface of the tooth, here the bonding surface of the fastening part is designed convexly curved at least in one direction. One consciously deviates from the shape of the surface of the tooth. The particular significance of the bonding surface 3 shaped in this manner is explained in more detail together with the method according to the invention.

If the orthodontic fastening part does not have the shape of a bracket, it then however has a suitable base 2 of the orthodontic fastening part and likewise accordingly has a bonding surface 3 which again here is convexly curved at least in one direction. If with the orthodontic fastening part it is the case of a button for example, then of course those elements which are required in combination with the closure spring are done away with.

With the method according to the invention a protector 20 is attached to the orthodontic fastening part 10. As the name already states, the protector is to protect the orthodontic fastening part 10 against contamination, in particular from the adhesive to be deposited. In order to achieve this the protector 20 has a shape which is complementary to the orthodontic fastening part. The protector sealingly covers the shape parts which cooperate with the force-transmitting elements for the connection. The protector 20 which is shaped in a manner which fits with the bracket 1 comprises a retaining bead 21 which may engage into the mounting 7 in the form of a beading. Furthermore the bracket has the complementary shape of the vertical bearing surface 4 as well as of the fastening element 5. A suitable web 22 corresponding to the groove 8 which runs perpendicularly to the base is present, as well as ribs 23 which have the complementary shape of the grid grooves 9, 9′, 9″ Usually the outer contour of the protector 20 is formed without undercuts. This however is not the case with the shown formation. Rather, a retaining jaw 24 is inwardly formed (recessed) which serves for the catching (snap), positive fit connection to an applicator which is yet to be described.

The bracket may also be designed of several parts. In this case the protector simultaneously serves as an assembly gauge (template) in order to hold the parts of the bracket together during the alignment and bonding.

If with the orthodontic fastening part it is the case of an element which is different to a bracket, then of course the protector 20 must be complementarily adapted to this shape. This complementary adaptation of the shape with certain shapes of orthodontic fastening parts may not be accomplished with a single part. Accordingly in such cases the protector must be designed such that it may be put together from two or several parts. In particular with buttons the protector for example may then consist of two half shells which may be put together with a positive fit. Again with a different shaping of the orthodontic fastening elements the protector again looks different, but it is clear to the man skilled in the art as to how he should fashion/shape a protector which is to form a complementary receiver shape for the orthodontic fastening part.

Finally for carrying out the method according to the invention one requires an applicator which is indicated in its entirety at 30. This applicator 30 has a receiver body 31 in which a receiver cavity 32 is inwardly formed, in which the complementary shape of the joined orthodontic fastening part and of the protector 20 protecting it is accommodated with a positive fit. The accommodation is not only effected with a positive fit but also in a sealed manner. A sealing plate 33 is integrally formed on the receiving body 31 and this plate may be sealingly pressed onto the surface of the tooth. A certain cavity remains between the sealing surface 33 and the bonding surface 3 of the orthodontic fastening part 10 applied in the applicator 30 together with the protector 20, and this cavity is filled with adhesive on application of the orthodontic fastening part. This remaining cavity is ensured by way of the fact that the bonding surface 3 at least in one direction is curved in a convex manner. At the same time the curvature is formed such that its highest point, when correctly applied with the protector 20 in the applicator, extends maximally until shortly below the sealing surface 33. It is thus ensured that a continuous adhesive film is formed between the tooth and the orthodontic fastening part 10.

In the embodiment shown here a retaining block 34 engages into the receiver cavity 32, and this block is integrally formed on the applicator 30 as one piece and, with the correct insertion of the protector 20 attached onto the orthodontic fastening part, latches into the retaining jaw 24 with a positive fit.

Aids for aligning the applicator or the orthodontic fastening part held therein relative to the tooth are present on the applicator 30. With these aids it is the case of an indicator (pointer) 35 which represents the tooth axis, and at least one angulation pointer 36 which is fastened on this pointer 35 and which renders the angulation alignment recognizable. The angulation pointer as a whole is longer than the maximal width of the applicator 30. The angulation indicator thus indicates the x-direction of the orthodontic fastening part to be fastened. This display in particular is significant with the application of brackets. The pointer 35 which indicates according to the y-direction may be provided with various continuations 37 which result in a grid on the y-axis. Two parallel running further aids in the form of torque indicators 38 are attached on the surface of the receiver body 31 practically perpendicular to the sealing surface 33. The torque indicators 38 render the alignment of the torque recognizable. The torque indicators thus run parallel to the z-axis and thus together with the other pointers which are present as aids permit an optically recognizable, considerably improved, and, as a result of this, more precise application of an orthodontic fastening part on a tooth.

The method according to the invention to be used has also be been essentially clarified by way of the description of the individual elements required for applying the method. Despite this, the individual steps of the method are indicated chronologically once again. In a first step the orthodontist on planning the tooth positional correction would select the type of orthodontic fastening part to be used. Subsequently he would cover the desired orthodontic fastening part by way of a protector 20 on the surface distant to the tooth. The protector thus with its complementary receiver surface protects those functional surfaces of the orthodontic fastening part which then serve for fastening suitable parts transmitting forces. The thus covered orthodontic fastening part together with the already mentioned protector 20 is applied into the receiver space 32 of a corresponding applicator, wherein the applicator has a shape which is designed complementarily to the parts 10 and 20. Where appropriate the adhesive is then deposited onto the bonding surface 3 with certain excess so that the remaining cavity between the bonding surface 3 and the sealing surface of the applicator 33 is completely filled. Subsequently the fastening part with the help of the applicator 3′ is aligned to and pressed onto the tooth in the correct position, whereupon the adhesive is left to cure. With a selection or plastics permeable to blue light for the protector and the applicator one may cure the adhesive in an optimal manner with a polymerization lamp. When the curing has been completed, one would then first remove the applicator and after this the protector is detached from the orthodontic fastening part. Finally any excess adhesive which is still present is removed from the tooth surface.

Preferably, for reasons of strength, one would manufacture the orthodontic fastening parts of materials which are common nowadays, specifically metal alloys or ceramic, glass or high-strength plastic. The protector 20 is preferably manufactured of a relatively soft plastic. It then adapts well to the required contours. The applicator too is preferably manufactured of plastic.

In practice, all three parts, specifically the orthodontic fastening part, the protector 20 and the applicator 30 must be matched to one another in shape. It is however indeed possible to design the outer contour of the protector always the same independently of the shape of the orthodontic fastening parts. In this case the applicator does not need to be adapted to various protectors but may always have the same shape.

The adaptation of the bonding surface 3 to the shape of the tooth is also done away with since this adaptation to the tooth is assumed by the contour of the applicator. Thus one requires less different shapes of orthodontic parts. The actual adaptation is preferably carried out on the sealing surface 33 of the applicator 30. Since this element is of plastic and has a corresponding elasticity, on the one hand this may be accomplished more quickly and on the other hand is less tricky since the elasticity may accommodate certain inaccuracies.

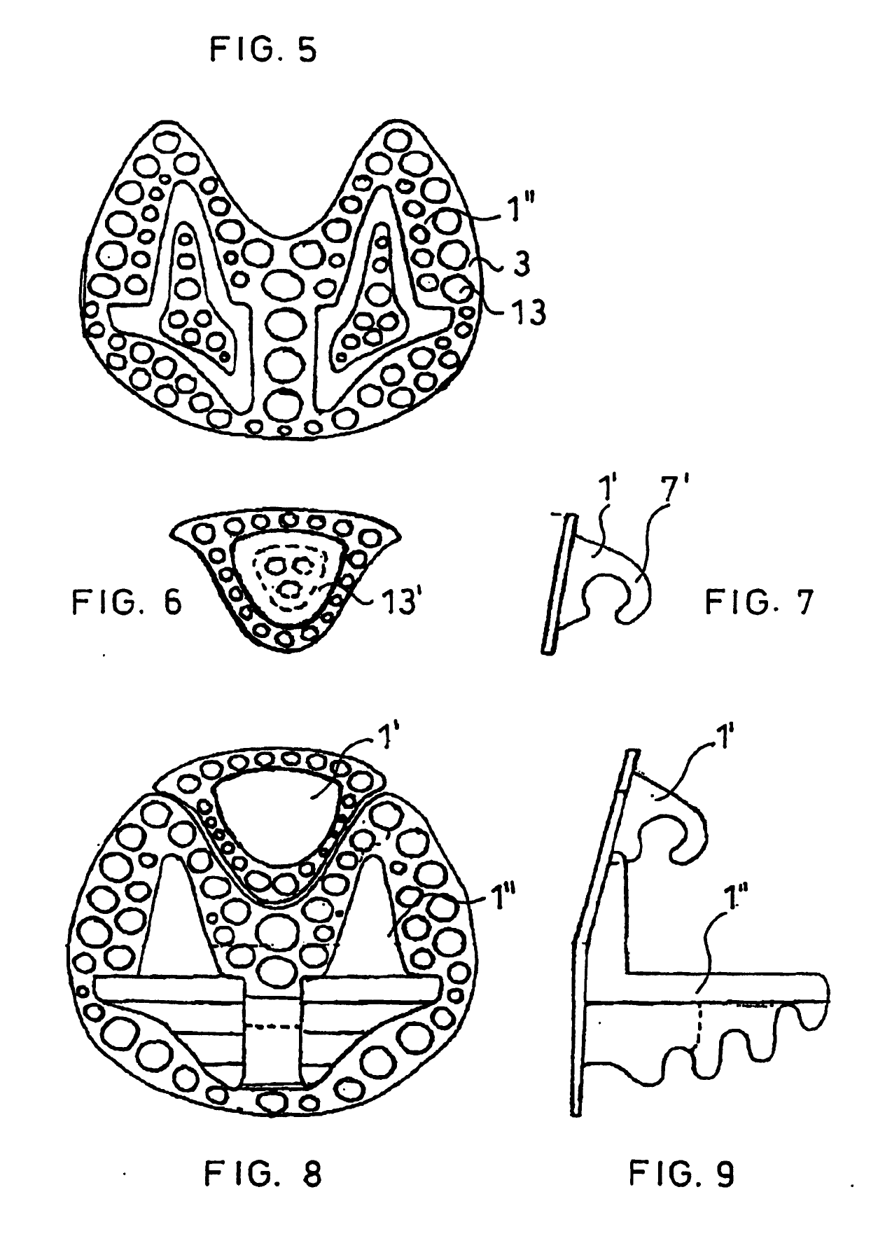

The sealing surface 33 of the applicator 20 permits the orthodontic fastening elements to be partly surrounded by film enveloping a plastic, and as a result of this the holding strength practically corresponds to the adhesion force of the adhesive. In order to achieve the optimal adhesion force one would preferably provide the bonding surface with a structure. The structure of such a bonding surface is shown in FIG. 5. The bonding surface 3 comprises suitable recesses or raised parts 13 which are irregularly distributed over the surface 3. In the present example a bonding surface of an orthodontic fastening element formed here of two parts is shown. This orthodontic fastening element may for example consists of a part 1′ as is seen in FIG. 7 in the lateral view and in FIG. 6 in a front view on the bonding surface, wherein here the hook 7′ may also be provided as a fastening hook per se or also as a mounting for a lock (latch) which cooperates with the second bracket part 1″. The protector 20 as well as the applicator 30 in this case at the same time act as an assembly gauge, wherein the two orthodontic fastening parts 1′ and 1″ are held in an exact relation to one another and are cast together in adhesive and cured. Apart from the two-part form shown here it is of course also possible to join the orthodontic fastening part of three or even more parts. This results in the advantage that with several simple basic elements one may configure various orthodontic fastening elements with a complex shape without at the same time having to shape a multitude of such complex orthodontic fastening parts in their entirety which must be adapted according to the demands of the patient.

It is envisaged for the user to be supplied in principle with a premanufactured kit by the manufacturer. At the same time the orthodontic fastening element to be installed is held directly on the applicator. Thanks to the industrial manufacture and assembly it is also possible to manufacture the protector as part of the applicator so that this no longer exists as a loose individual part. Indeed with multi-part orthodontic fastening elements these individual parts may be inserted into the applicator in an exactly fitting manner so that the applicator may assume the protector function. At the same time it is possible to manufacture the applicator as an outer shell with all direction indicators 36, 37 and 38 of a relatively hard plastic shell, whilst the protector part of soft, i.e. castable plastic mass is molded, into which the orthodontic fastening element may be inserted in a manner accurate to shape.

If the method asserts itself then it is very likely for the manufacturer of orthodontic fastening elements to already provide these from the very beginning with corresponding protectors accurate to shape. In this case, step b) of the method according to the invention is undergone by the manufacturer of the orthodontic fastening parts.

The enormous advantages of the method as a result of this lie in the reduction of the work effort for the orthodontist as well as in the improved accuracy of attachment of these orthodontic fastening parts. The orthodontist also does not need to keep in stock so much different orthodontic fastening parts which are relatively expensive.

### LIST OF REFERENCE NUMERALS

1 bracket
2 base of the bracket part
3 bonding surface of the base
4 vertical bearing surface for alloyed correction arches
5 fastening element
5′ horizontal bearing surface for alloyed correction arches
5″ inlay groove for alloyed correction arches
6 lock or lock (latch) spring of a wire bow (archwire)
7 bearing in the form of a beading
8 groove perpendicular to the base
9′, 9″, 9′″ latching notches
10 orthodontic fastening part
13 recesses or raised parts
20 protector
21 retaining bead
22 web
23 ribs
24 retaining jaw
30 applicator
31 receiver body
32 receiver cavity
33 sealing surface
34 retaining block
35 pointer
36 angulation pointer
37 continuations
38 torque indicators

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1-23. (canceled)

24. A method for the correct application of an orthodontic fastening part onto a tooth comprising:
a) selecting an orthodontic fastening part which is suitable for the correction of a tooth position,
b) covering the fastening part on a surface distant to the tooth with a protector which has a receiver surface which is complementary to the fastening part,
c) accommodating the covered fastening part with the protector in a complementary applicator with a positive fit,
d) depositing the adhesive into an opening of the applicator, said applicator facing the tooth, and thus also onto the fastening part,
e) aligning the fastening part on the tooth surface with the help of the applicator using aids on the applicator,
f) curing the adhesive,
g) removing the applicator, and
h) removing the protector.

25. A method according to claim 24,
wherein an end contour of the applicator is adapted to the tooth surface in a bonding region before depositing the adhesive.

26. A method according to claim 24,
wherein the orthodontic fastening part is attached to the protector in a preassembled manner.

27. A method according to claim 24,
wherein the curing of the adhesive is effected by way of a polymerization lamp.

28. An orthodontic fastening part for the adhesive or bonding connection to a tooth surface comprising a bonding surface which is curved in a convex manner in at least one direction.

29. An orthodontic fastening part according to claim 28,
wherein the fastening part is of several parts.

30. An orthodontic fastening part according to claim 28,
wherein the bonding surface is provided with a structure and surface which increase the bonding.

31. A protector for accommodating an orthodontic fastening part to be bonded, the protector comprising a complementary shaping accommodating the orthodontic fastening part such that parts of the fastening part serving for the connection to force-transmitting elements are sealingly covered.

32. A protector according to claim 31,
wherein the protection together with the orthodontic fastening part has a shape having an outer contour without undercuts.

33. A projector according to claim 31,
wherein a recess for a meshingly engaging connection to an applicator is present in the outer contour.

34. A protector according to claim 31,
wherein the protector is manufactured of plastic.

35. A protector according to claim 31,
wherein the protector is composed of several pieces.

36. A protector according to claim 31,
wherein the protector accommodates an orthodontic fastening part of several pieces, and wherein the protector simultaneously serves as an assembly gauge which holds together the pieces in a positional correct manner during application.

37. An applicator for the positionally correct attachment of an orthodontic fastening part which is protected with a protector, the applicator comprising a receiver cavity in which the orthodontic fastening part where appropriate with the protector is accommodated in a sealed and complementary manner and an intermediate space as an adhesive receiver space remains between a sealing surface of the applicator and a bonding surface of the orthodontic fastening part and wherein at least one aid for aligning the applicator or the orthodontic fastening part held therein relative to the tooth is present on the applicator.

38. An applicator according to claim 37,
wherein the applicator includes a sealing surface comprising an edge running around the inserted orthodontic fastening part in a closed manner which defines a surface which contacts or runs distant to a bonding surface of the inserted fastening part.

39. An applicator according to claim 37,
wherein the applicator includes an angulation indicator which renders the angulation alignment recognizable.

40. An applicator according to claim 37,
wherein the applicator includes a torque indicator which renders the torque alignment recognizable.

41. An applicator according to claim 37,
wherein the applicator includes a torque indicator running at least approximately perpendicular to an axis of the tooth and perpendicular to a base surface of an arch receiver slot of the orthodontic fastening part applied in the applicator.

42. An applicator according to claim 39,
wherein the aid is integrally formed on the applicator.

43. An applicator according to claim 37,
wherein the applicator is manufactured of plastic.

44. An applicator according to claim 39, further comprising:
a rotation indicator integrally formed on the angulation indicator indicating the tooth alignment, the indicator running essentially parallel to an arch receiving slot.

45. An applicator according to claim 44,
wherein a plurality of rotation indicators run parallel to one another.

46. An applicator according to claim 41,
wherein two torque indicators run parallel to one another.

47. An applicator according to claim 37,
wherein the applicator is provided with a protector which is integrally formed therein.

48. An applicator according to claim 37,
wherein the aid is integrally formed on the applicator.

49. An applicator according to claim 41,
wherein the aid is integrally formed on the applicator.
